(19) United States
(12) Patent Application Publication
(10) Pub. No.: US 2013/0294770 A1
(43) Pub. Date: Nov. 7, 2013

(54) MONITORING SYSTEM, MONITORING METHOD AND MONITORING PROGRAM

(71) Applicants: Tomoyuki Hino, Tokyo (JP); Masahiro Sakauchi, Tokyo (JP); Akio Tajima, Tokyo (JP)

(72) Inventors: Tomoyuki Hino, Tokyo (JP); Masahiro Sakauchi, Tokyo (JP); Akio Tajima, Tokyo (JP)

(21) Appl. No.: 13/994,656

(22) PCT Filed: Dec. 16, 2011
(86) PCT No.: PCT/JP2011/079167

§ 371 Date: Jun. 19, 2013

(30) Foreign Application Priority Data
Dec. 24, 2010 (JP) 2010-287854

(51) Int. Cl. H04B 10/07

(52) U.S. Cl. CPC H04B 10/07
USPC 398/34

(57) ABSTRACT

A monitoring system which enables monitoring of a transponder accommodated in an optical path in a transmission node and a node according to their operation conditions is provided. The monitoring system comprises a monitor control management unit connected to at least one of ports of wavelength selective switches which monitors an inspection signal or an operation signal, and a control unit which controls the wavelength selective switch so as to enable monitoring by the monitor control management unit.

### CROSS REFERENCE TO RELATED APPLICATIONS

This application is a National Stage of International Application No. PCT/JP2011/079167 filed Dec. 16, 2011, claiming priority based on Japanese Patent Application No. 2010-287854 filed Dec. 24, 2010, the contents of all of which are incorporated herein by reference in their entirety.

### TECHNICAL FIELD

The present invention relates to a monitoring system, a monitoring method and a monitoring program for an optical path and a transponder accommodated in an optical cross connect device and an optical Add Drop multiplexer capable of switching, branching and inserting an optical signal transparently.

### BACKGROUND ART

Explosive spreading of Internet has been followed by the popularity of optical transmission networks using wavelength division multiplexing (WDM) techniques enabling high traffic transmission. In order to be flexibly adapted to a change of a demand for communication between transmission nodes, such optical transmission networks use an optical cross connect/reconfigurable optical Add Drop multiplexer (OXC/ROADM) capable of switching, branching and inserting an optical signal being transparent as an optical transmission device.

In such an OXC/ROADM device, a key component in charge of a function of inserting/branching an optical signal with an arbitrary wavelength into/from a WDM signal and a connection function of selecting an optical signal of an arbitrary wavelength and outputting the same to an arbitrary output port is a wavelength selective switch.

Wavelength selective switch (WSS) is proposed to have various kinds of structures such as a micro electro mechanical system (MEMS) other than an arrayed-waveguide grating (AWG) and an optical matrix switch.

FIG. 10 shows a structure of a ROADM optical node system as recited in Patent Literature 1. With reference to FIG. 10, an optical coupler 1001 is applied to an input WDM line unit to branch light. To one of the branched lines, a 1×N wavelength selective switch (WSS) 1002 for Drop is applied and connected to a transponder 1003.

Block diagram of the 1×N wavelength selective switch (WSS) 1002 for Drop is shown here in FIG. 11. With reference to FIG. 11, the 1×N wavelength selective switch (WSS) 1002 for Drop has a function of outputting an optical signal with an arbitrary wavelength to an arbitrary output port among a number N of output ports. More specifically, a signal applied through a Port A1 in the figure is demultiplexed by an AWG 1101 and divided for ports, a Port B1 through a Port Bn, on a wavelength basis. Thereafter, an optical matrix switch 1102 forms an optical path in a desired transponder 1003.

In FIG. 10, to the other branched input WDM line unit, an N×1 wavelength selective switch (WSS) 1004 for Add is applied and connected to an output WDM line.

Block diagram of the N×1 wavelength selective switch (WSS) 1004 for Add is here shown in FIG. 12. With reference to FIG. 12, the N×1 wavelength selective switch (WSS) 1004 for Add has a function of selecting an arbitrary wavelength from each optical signal applied through the number N of input ports, wavelength-division multiplexing the same and outputting the obtained signal through the output port. More specifically, an optical path is formed by the optical matrix switch 1102 such that signals from the WDM line and the transponder 1003 have their predetermined wavelengths multiplexed at the Port A1 in the figure.

The transponder 1003 is an apparatus having an optical transmission and reception function of accommodating a client signal to connect to the WDM line unit. Although the transponders 1003 are separately denoted as one for the Add unit and the other for the Drop unit in the figure, they are generally provided as one unit.

Under these circumstances, along with increasing complication of networks, optical transmission networks using current WDM techniques have been demanding more from a monitor which monitors a state of signals.

In the ROADM optical node system recited in the above-described Patent Literature 1, a monitoring function is generally accommodated in a WDM line unit or a transponder unit.

Monitor in the WDM line unit, which is called Optical Channel Monitor (OCM), monitors a wavelength/signal power of an optical signal propagating in a network.

Monitor in the transponder unit, which is called a wavelength locker, monitors a signal power of light dropped from laser by an optical coupler to stabilize a wavelength.

Other than an OCM and a wavelength locker which monitor such signal power and wavelength, methods of monitoring an optical path or the transponder 1003 include those recited in Patent Literature 2, Patent Literature 3 and Patent Literature 4. Patent Literature 2 proposes a technique related to a monitoring system for monitoring a start-up setting state, Patent Literature 3 proposes a technique related to a monitoring system for fault self-detection and Patent Literature 4 proposes a technique related to a system for monitoring normality of an optical path.

Patent Literature 2 proposes a method of start-up setting of a backup or standby system transponder, in which start-up is realized by using wavelength different from an operation wavelength and the start-up wavelength is filtered by AWG. After setting a variable optical attenuator (VOA) and a bias in the transponder, the operation wavelength is lastly set. Thus using a start-up signal whose wavelength is different from that of an operation signal prevents transmission of a signal being set to start-up to a WDM line.

Patent Literature 3 relates to proposal of a transmission node device capable of fault self-detecting in which a closed optical path is formed between transmission and reception of a transponder and connected through a shading unit such as liquid crystal. When detecting a fault, transmitting signals between the transmission and the reception in a closed transmission node enables detection of a fault.

Patent Literature 4 relates to proposal of performing the inspection of an optical path by a simple structure, in which ensuring an extra number of ports of the optical matrix switch for optical path inspection enables confirmation of normality of an optical path with a small-scale configuration.

As related art, structure is recited in Patent Literature 1 for monitoring each signal which is obtained by branching an output of a wavelength blocker.
Patent Literature 1: Japanese Patent Laying-Open No. 2010-56676
Patent Literature 2: Japanese Patent Laying-Open No. 2006-42155
Patent Literature 3: Japanese Patent Laying-Open No. 2003-60582
Patent Literature 4: Japanese Patent Laying-Open No. 2006-311248

As optical networks will be more highly meshed in the near feature, it is expected that the number of paths to be accommodated in an optical node will be increased and various components will be introduced to an optical node for the purpose of realizing a ROADM optical node system having no constraints on a path or a wavelength to complicate optical paths in the node. On the other hand, components in such an optical node will be more highly integrated to expect transition from current one-to-one relationship between a transponder and a monitor represented by an OCM or a wavelength locker to a relationship between a plurality of transponders and a monitor.

With such complexity of optical paths and integration of transponders in a ROADM node, current OCM and wavelength lockers will have difficulties in signal quality management and monitoring in future ROADM optical nodes.

Regarding signal quality management or monitoring, application of the start-up setting monitoring system as recited in Patent Literature 2 to a ROADM optical node system involves a problem of low reliability because a wavelength for start-up setting monitoring differs from a real operation wavelength.

Applying the monitoring system for fault self-detection recited in Patent Literature 3 to a ROADM optical node system will involve a problem of emission of an inspection wavelength to a WDM line.

Applying the optical path monitoring system recited in Patent Literature 4 to a ROADM optical node system will result in hindering expandability of a monitor port and increasing the size of a switch due to monitoring.

In addition, the wavelength blocker recited in Patent Literature 1 is used for monitoring a signal of a WDM line unit, which largely differs from a monitor for an optical path and a transponder in an optical node in both structure and effects.

### OBJECT OF THE INVENTION

An object of the present invention is to provide a monitoring system enabling an active transponder, and a backup/standby transponder to be monitored according to their operation conditions in an optical path in a node including various components, and a monitoring method and a monitoring program therefor.

### SUMMARY

According to a first exemplary aspect of the invention, a monitoring system comprises a monitor control management unit connected to at least one of ports of wavelength selective switches which monitors an inspection signal or an operation signal, and a control unit which controls the wavelength selective switch so as to enable monitoring by the monitor control management unit.

According to a second exemplary aspect of the invention, a monitoring method of a monitoring system having an optical monitoring function comprising the steps of monitoring an inspection signal or an operation signal by a monitor control management unit connected to at least one of ports of wavelength selective switches, and controlling the wavelength selective switch so as to enable monitoring by the monitor control management unit.

According to a third exemplary aspect of the invention, a monitoring program operable on a computer which realizes a monitoring system having an optical monitoring function, which causes the computer to execute the processing of monitoring an inspection signal or an operation signal by a monitor control management unit connected to at least one of ports of wavelength selective switches, and controlling the wavelength selective switch so as to enable monitoring by the monitor control management unit.

The present invention enables realization of a highly reliable ROADM optical node system by realizing a monitoring system which enables monitoring of a backup/standby transponder and an active transponder accommodated in an optical path in a node including various components according to their operation conditions, and a monitoring method and a monitoring program therefor.

### BRIEF DESCRIPTION OF THE DRAWINGS

FIG. 1 is a block diagram showing a structure of a monitoring system for a transponder in an optical node according to a first exemplary embodiment of the present invention;

FIG. 2 is a block diagram showing a structure of a wavelength selective switch for Drop for use in FIG. 1;

FIG. 3 is a block diagram showing a structure of a wavelength selective switch for Add for use in FIG. 1;

FIG. 4 is a diagram showing an input/output wavelength table of an AWG for use in FIG. 1;

FIG. 5 is a block diagram showing a structure of the monitoring system for a transponder in an optical node according to the first exemplary embodiment of the present invention which is adapted to a plurality of paths;

FIG. 6 is a block diagram showing a structure of a monitoring system for a transponder in an optical node according to a second exemplary embodiment of the present invention;

FIG. 7 is a block diagram showing a structure of a wavelength selective switch for Drop for use in FIG. 6;

FIG. 8 is a block diagram showing a structure of a wavelength selective switch for Add for use in FIG. 6;

FIG. 9 is a diagram showing an input/output wavelength table of an AWG for use in FIG. 6;

FIG. 10 is a block diagram showing a structure of an optical node system recited in Patent Literature 1;

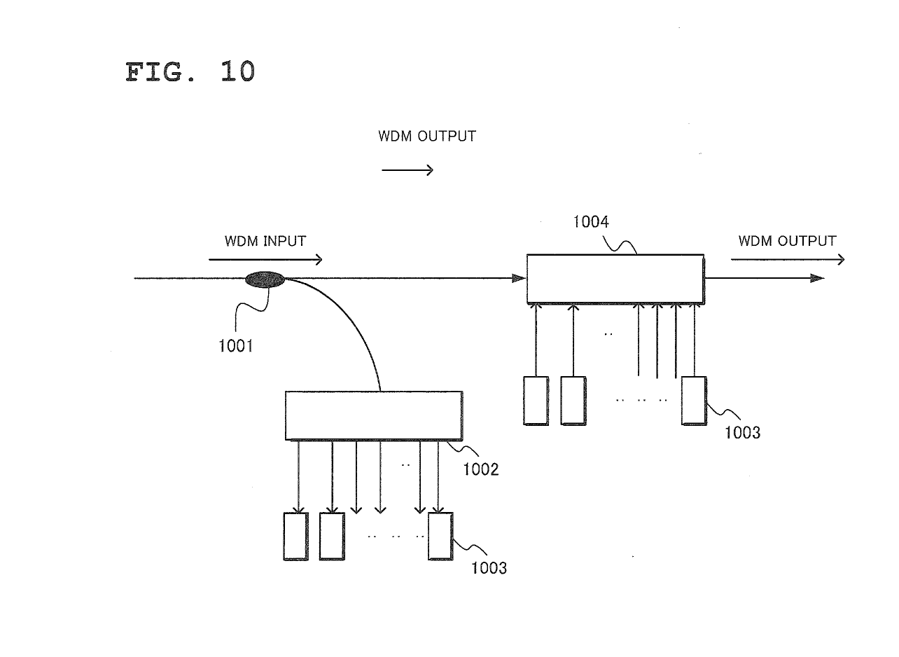

FIG. 11 is a block diagram showing an example of a structure of a 1×N wavelength selective switch for Drop of the optical node system for use in FIG. 10; and

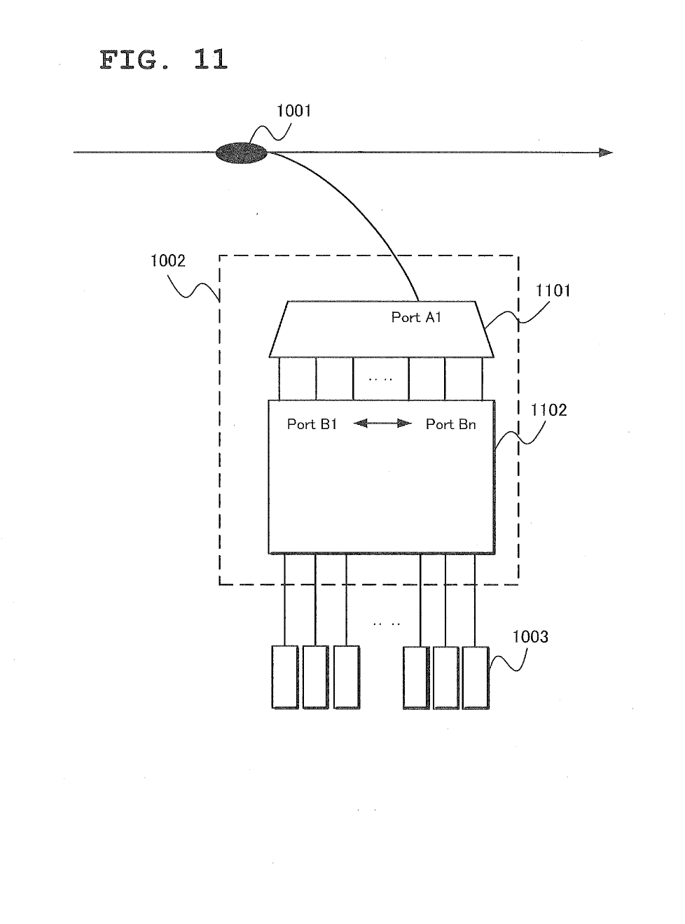

FIG. 12 is a block diagram showing an example of a structure of an N×1 wavelength selective switch for Add of the optical node system for use in FIG. 10.

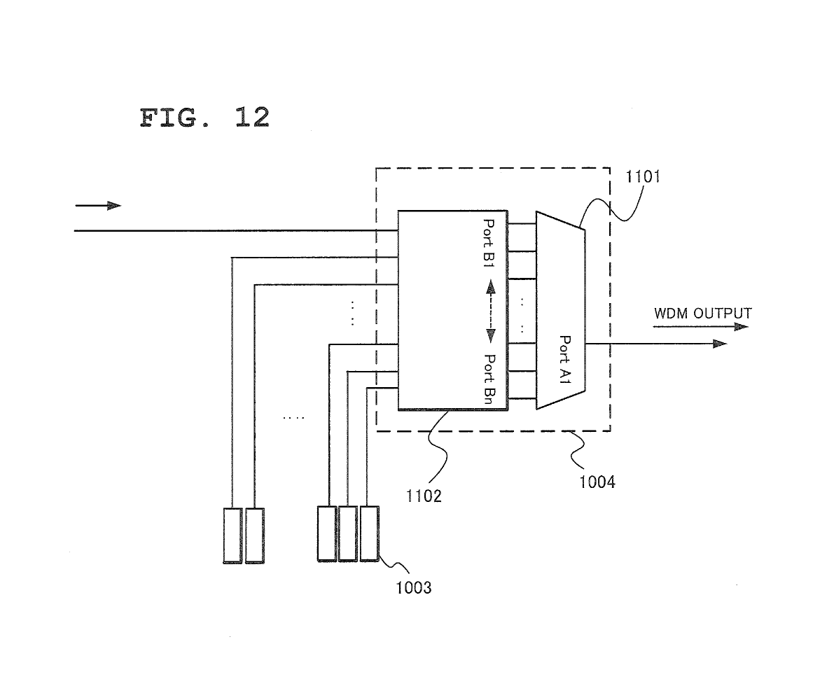

### EXEMPLARY EMBODIMENTS

In order to clarify the foregoing and other objects, features and advantages of the present invention, exemplary embodiments of the present invention will be detailed in the following with reference to the accompanying drawings. Other technical problems, means for solving the technical problems and functions and effects thereof other than the above-described objects of the present invention will become more apparent from the following disclosure of the exemplary embodiments.

The monitoring system for an optical path and a transponder in an optical node according to the present invention is directed to a monitoring method of connecting at least one of ports of an arrayed-waveguide grating (AWG) in a wavelength selective switch to a monitor control management unit including an optical receiver which monitors light, an optical transmitter for checking an optical path and an optical matrix switch controller, in which an optical matrix switch in the wavelength selective switch is controlled such that a path for inspection from a monitor port or an inspection signal from the transponder passes through a designated path to execute feedback control for the transponder based on information obtained by the monitor control management unit.

In all the drawings, like components are identified by the same reference numerals to appropriately omit description thereof.

### First Exemplary Embodiment

First exemplary embodiment of the present invention will be detailed with reference to the drawings. In the following drawings, no description is made of a structure of a part not related to a gist of the present invention and no illustration is made thereof.

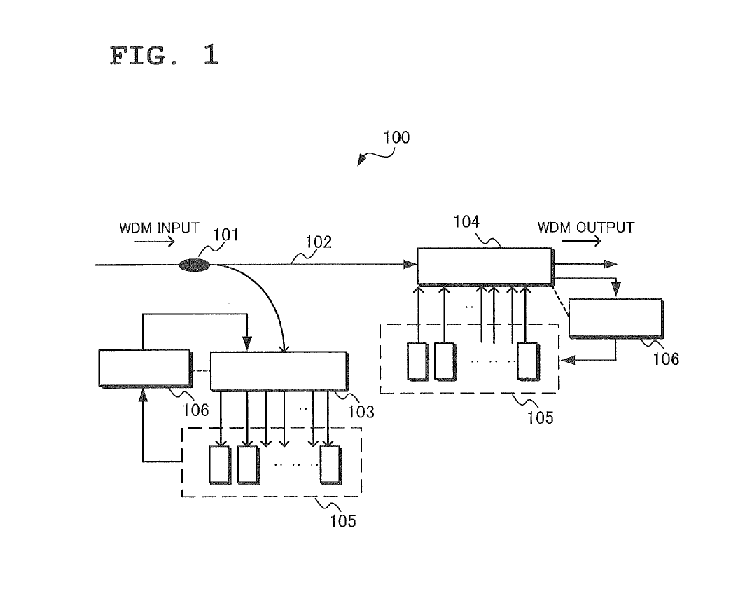

FIG. 1 is a block diagram showing a structure of a monitoring system 100 for an optical path and a transponder in an optical node according to the first exemplary embodiment of the present invention. The monitoring system 100 for an optical path and a transponder in an optical node according to the present exemplary embodiment includes a wavelength selective switch (WSS) 103 for Drop and a wavelength selective switch (WSS) 104 for Add arranged in Add/Drop units on WDM lines 102 branched by an optical coupler 101.

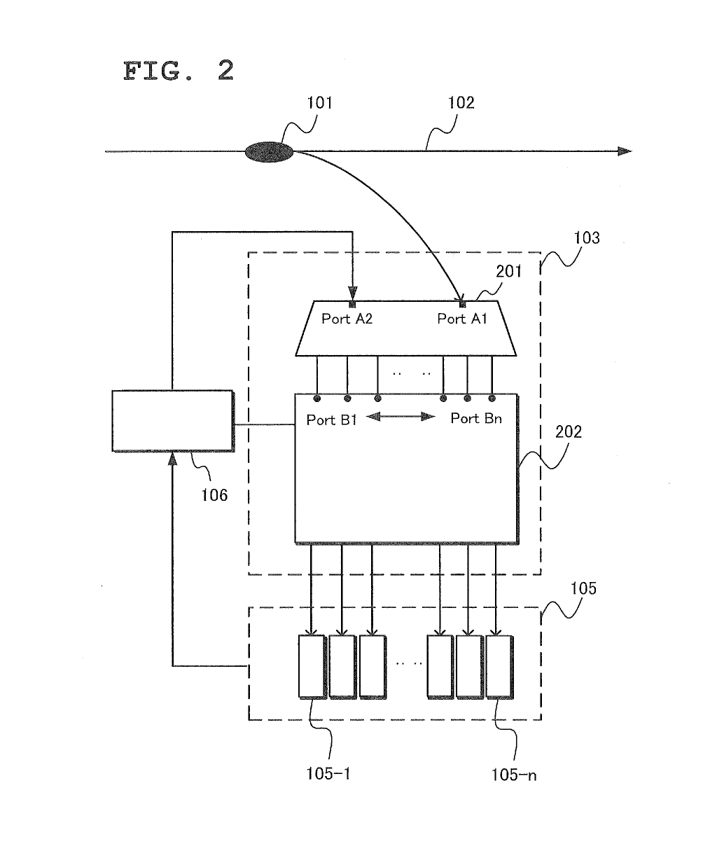

FIG. 2 is a block diagram showing a structure of the wavelength selective switch (WSS) 103 for Drop to a transponder in the optical node according to the first exemplary embodiment of the present invention.

With reference to FIG. 2, a Port A1 is connected to the optical coupler 101 and a Port A2 is connected to a monitor control management unit 106.

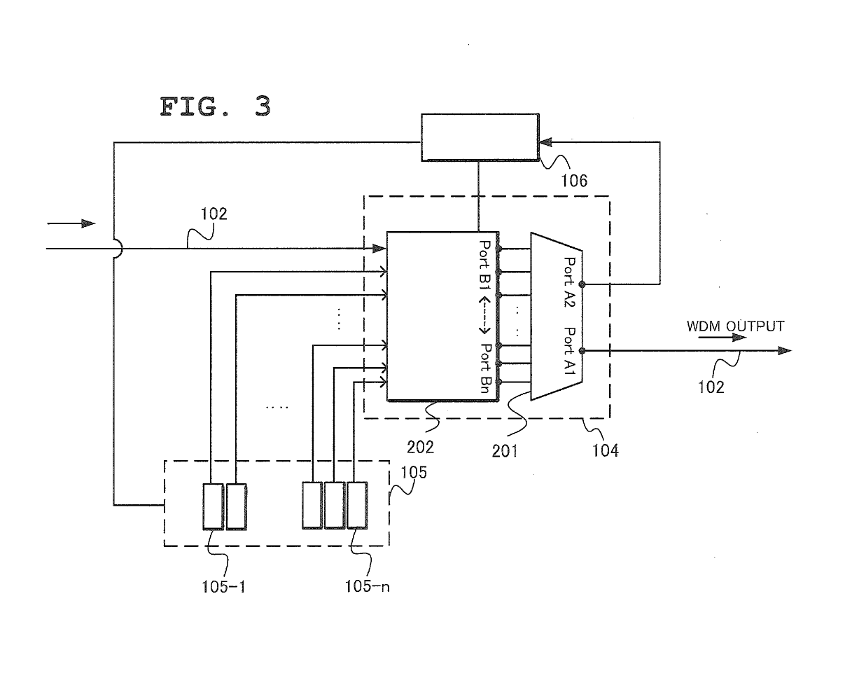

FIG. 3 is a block diagram showing a structure of the wavelength selective switch (WSS) 104 for Add from the transponder in the optical node according to the first exemplary embodiment of the present invention.

The block diagrams shown in FIG. 1 through FIG. 3 are simplified for the purpose of explanation of the exemplary embodiment. In the Add/Drop units between the WDM lines 102 and a transponder 105, not only the wavelength selective switches 103 and 104 but also such an optical component as a wavelength tunable filter, an optical amplifier, an isolator or a VOA may be introduced.

The wavelength selective switches 103 and 104 each include an arrayed-waveguide grating (AWG) 201 and an optical matrix switch 202, in which the transponder is connected to the optical matrix switch side and one of the ports of the AWG 201 is connected to the WDM line 102. In addition, at least one of the ports of the AWG 201 in the wavelength selective switch is connected to the monitor control management unit 106.

The monitor control management unit 106 includes an optical receiver which monitors light, an optical transmitter for checking an optical path and an optical matrix switch controller. The structure of the wavelength selective switch (WSS) 103 for Drop shown in FIG. 2 requires an optical transmitter for checking an optical path and an optical matrix switch controller as a function of the monitor control management unit 106. The structure of the wavelength selective switch (WSS) 104 for Add shown in FIG. 3 requires an optical receiver for monitoring light and an optical matrix switch controller.

The monitor control management unit 106 which controls the wavelength selective switches controls the optical matrix switch 202 in the wavelength selective switch such that a path for inspection from the monitor port or an inspection signal from the transponder passes through a predetermined path. The unit also executes feedback control for the transponder 105 based on information obtained by the monitor control management unit 106.

The optical matrix switch 202 in each of the wavelength selective switches 103 and 104 is a switch formed of a planar lightwave circuit (PLC) or a micro electro mechanical systems (MEMS), structure of which is not limited. The optical matrix switch 202 in each of the wavelength selective switches 103 and 104 preferably has a non-blocking structure in which a signal path from each input port fails to collide with each other.

The optical receiver which monitors light in the monitor control management unit 106 functions as a monitor capable of seizing a state of an optical signal such as a wavelength, optical power, modulation setting and a polarized wave state and its monitoring function has no limitation.

### (Description of Operation of the First Exemplary Embodiment)

Regarding the monitoring system 100 for an optical path and a transponder in an optical node according to the present exemplary embodiment, its operation will be recited separately with respect to three usages for start-up setting monitoring, failure detection monitoring and active signal monitoring.

Assume that a number n of the transponders 105 (105-1 to 105-n) are provided. Although each of the transponders 105-1 to 105-n has its operation wavelength not actually limited because of its tunable function, it is assumed to operate at a wavelength of λn for explanation's sake. More specifically, the transponder 105-1 in FIG. 2 is assumed to operate at λ1 and the transponder 105-n in FIG. 2 is assumed to operate at λn.

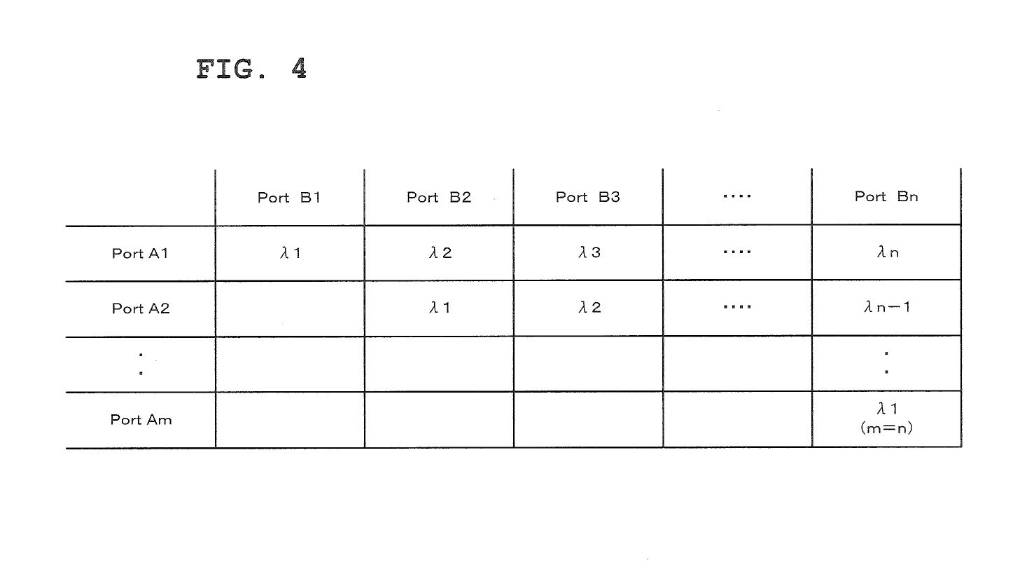

Input/output wavelength table of the AWG 201 is shown in FIG. 4. The AWG 201 has its input/output wavelength depending on a port. In other words, an output port position changes depending on an input port position. In the first exemplary embodiment, at least one (Port A1) of the ports of the AWG 201 in each of the wavelength selective switches 103 and 104 is connected to the monitor control management unit 106.

Use for start-up setting is mainly applied to the wavelength selective switch (WSS) 104 for Add for the transponder 105 in the optical node shown in FIG. 3. This usage is intended to monitor start-up of the transponder 105 being constantly stable.

The output of the transponder 105-1 should be set to a Port B1 in order to prevent output of the transponder 105-1 to the WDM output 102 before the transponder 105-1 newly started up has stable operation. However, set the output of the transponder 105-1 to a Port B2 here by controlling the optical matrix switch 202 until operation of the transponder 105-1 goes stable. Then, after the operation of the transponder 105-1 stabilizes, set the output of the transponder 105-1 to the Port B1 to start operation.

As an example, assume that it is set by a control plane of the network such that the transponder 105-1 operates at the wavelength of λ1. In this case, the monitor control management unit 106 needs to set a path of the optical matrix switch 202 to have a signal of the transponder 105-1 set to the Port B1 as an operation port (Port A1 for AWG output in FIG. 4). At the time of start-up setting, however, it is necessary to check a wavelength, optical power, modulation setting or a polarized wave state until it stabilizes.

Thus, at the time of start-up, set the optical matrix switch 202 so as to set a path to the Port B2 (Port A2 for AWG output in FIG. 4). Being applied to the Port A2, none of signals in start-up operation from the transponder 105-1 will be output to the WDM line 102. By the monitoring, check the information of the signal and when start-up setting to the setting state is completed, switch the optical matrix switch 202 to the Port B1 (Port A1 for AWG output in FIG. 4). As a result, the operation signal with λ1 from the transponder 105-1 is output to the WDM line 102 and operated.

As described in the foregoing, use for start-up setting allows one monitor port 106 to execute start-up setting of the plurality of transponders 105 and additionally enables start-up setting having highly reliable signal quality because of being start-up monitoring at an operation wavelength.

Use for failure detection is applied to the structures of both the wavelength selective switch (WSS) 103 for Drop and the wavelength selective switch (WSS) 104 for Add for the transponder in the optical node. This usage is intended to monitor reliability of a backup transponder or a standby transponder for failure detection by periodically operating the same.

In a case of failure detection on the Drop side, for determining whether the transponder 105-1 operates normally or not, although an output of the transponder 105-1 should be originally set to the Port B1 and be correlated with the Port A1 corresponding to the Port B 1, control the optical matrix switch 202 to cause a signal from the monitor control management unit 106 to enter through the Port A2 and then enter the transponder 105-1.

In a case of failure detection on the Add side, for determining whether the transponder 105-1 operates normally or not, although an output of the transponder 105-1 should be originally set to the Port B1 and be correlated with the Port A1 corresponding to the Port B1, control the optical matrix switch 202 to cause the output from the transponder 105 to go out through the Port A2 and then enter the monitor control management unit 106.

Inspection of the wavelength of λ1 of the standing by transponder 105-1 for failure detection will be recited as an example separately with respect to failure detection on the Drop side (see FIG. 2) and failure detection on the Add side (see FIG. 3).

First, in a case of failure detection on the Drop side, enter a signal from an optical transmitter for optical path check in the monitor control management unit 106 through the Port A2 of the AWG 201 (Port B2 for optical switch input in FIG. 4) to control the optical matrix switch 202 to form an optical path for the transponder 105-1 to be inspected.

In a case of failure detection on the Add side, the monitor control management unit 106 sets the optical matrix switch 202 such that a signal from the transponder 105-1 to be inspected enters the Port A2 of the AWG 201 (Port B2 for optical switch input in FIG. 4).

As described in the foregoing, use for failure detection enables failure detection of a plurality of transponders 105-1 to 105-n by one monitor port 106.

Use for an active monitor is applied mainly to the structure of the wavelength selective switch (WSS) 104 for Add for the transponder in the optical node. This usage is intended to monitor an operation signal during its operation as an active monitor.

For monitoring operation of the transponder 105-1 during its operation, controlling the optical matrix switch 202 such that 99% out of 100% of the output of the transponder 105-1 goes out through the Port A1 and the remaining 1% through the Port A2 enables operation by the 99% output from the Port A1 to be continued and the 1% output from the Port A2 to be detected by the monitor control management unit 106, thereby monitoring operation of the transponder 105-1.

As an example, assume that the transponder 105-1 operates at the wavelength of λ1 whose signal is to be monitored during operation.

In this case, the monitor control management unit 106 sets a path of the optical matrix switch 202 to the Port A1 which will be an operation port (Port B1 for switch output in FIG. 4). One 2×2 optical switch forming the optical matrix switch 202 for which the path is set is normally on/off driven. In other words, one input signal is output in a branching ratio 100:0 or 0:100.

When in operation by the active monitor, operate the optical switch as a branching ratio variable coupler. More specifically, with a branching ratio 99:1 for one input signal, for example, set the optical matrix switch 202 to set a path such that 99 is input to the Port A1 and used as an operation signal and the remaining 1 to the Port A2 (Port B2 for switch output in FIG. 4).

Inputting a part of the operation signal to the Port A2 as a monitor port enables the monitor to check the information of the signal during operation.

### (Effects of the First Exemplary Embodiment)

Thus structured monitoring system 100 for an optical path and a transponder in an optical node according to the present exemplary embodiment provides a monitoring system in which one of ports on the WDM line side of the arrayed-waveguide grating (AWG) 202 in each of the wavelength selective switches 103 and 104 is connected to the monitor control management unit 106 including an optical receiver which monitors light, an optical transmitter for checking an optical path and an optical matrix switch controller and in which the optical matrix switch in the wavelength selective switch is controlled such that a path for inspection from the monitor port (Port A2) or an inspection signal from the transponder passes through a predetermined path to execute feedback control for the transponder 105 based on information obtained by the monitor control management unit 106.

Such system enables monitoring, in an optical path in an optical node including various components, of an optical path and a transponder in an optical node which allows a backup/standby transponder or an active transponder to be monitored according to their operation conditions, thereby increasing reliability of a ROADM optical node system.

While the above-described first exemplary embodiment has been described with respect to a case where the transponder 105-1 operates at 21, setting is not limited as such and the transponder accommodated should operate at a designated operation wavelength.

When the necessary number of paths or wavelengths is required in the system, it is only necessary to upgrade the wavelength selective switch or the transponder which forms the Add/Drop unit provided in the ROADM optical node system with no limitation on the number of paths, the port size of the wavelength selective switch and the number of transponders.

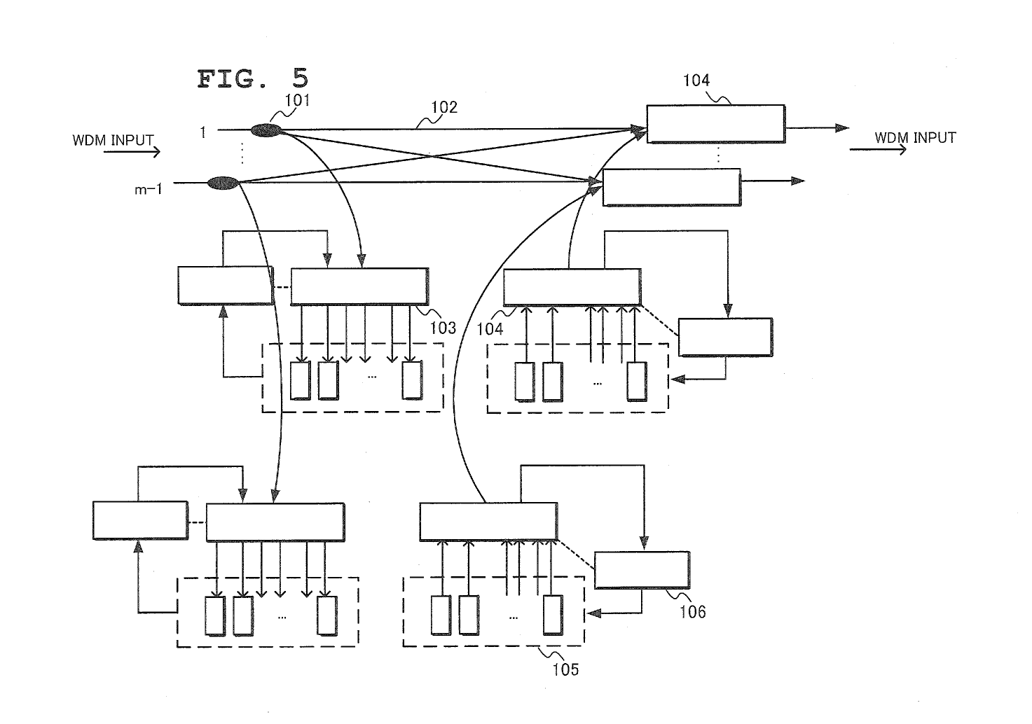

FIG. 5 shows a ROADM optical node system adapted to a plurality of paths (1 to 1-m) which is an expansion of the monitoring system 100 for an optical path and a transponder in an optical node according to the first exemplary embodiment of the present invention. This mode applies two wavelength selective switches (WSS) 104 to the Add unit. WDM signal from each path is branched by the optical coupler 101. The Drop unit connects as many wavelength selective switches (WSS) 103 for Drop as the number of paths (1-m) to each path. The Add unit similarly connects as many wavelength selective switches (WSS) 104 for Add as the number of paths. The optical coupler 101 shown in FIG. 5 may be a wavelength selective switch.

### Second Exemplary Embodiment

Second exemplary embodiment of the present invention will be detailed with reference to the drawings. In the following drawings, no description is made of a structure of a part not related to a gist of the present invention which is not shown.

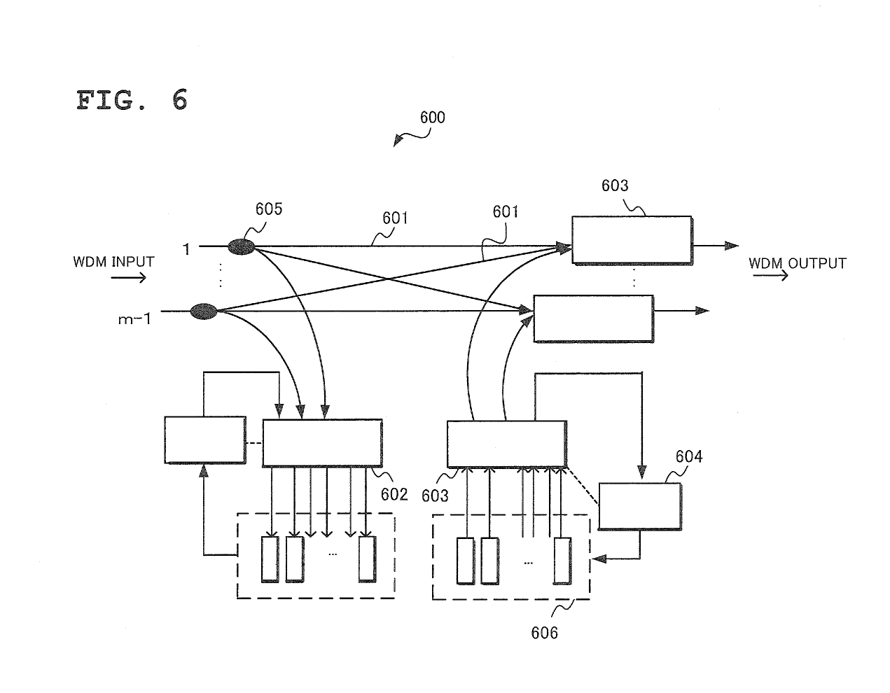

FIG. 6 is a block diagram showing a structure of a monitoring system 600 for an optical path and a transponder in an optical node according to the second exemplary embodiment of the present invention. The monitoring system 600 for an optical path and a transponder in an optical node according to the present exemplary embodiment includes a wavelength selective switch (WSS) 602 for Drop and a wavelength selective switch (WSS) 603 for Add arranged in Add/Drop unit on WDM lines 601.

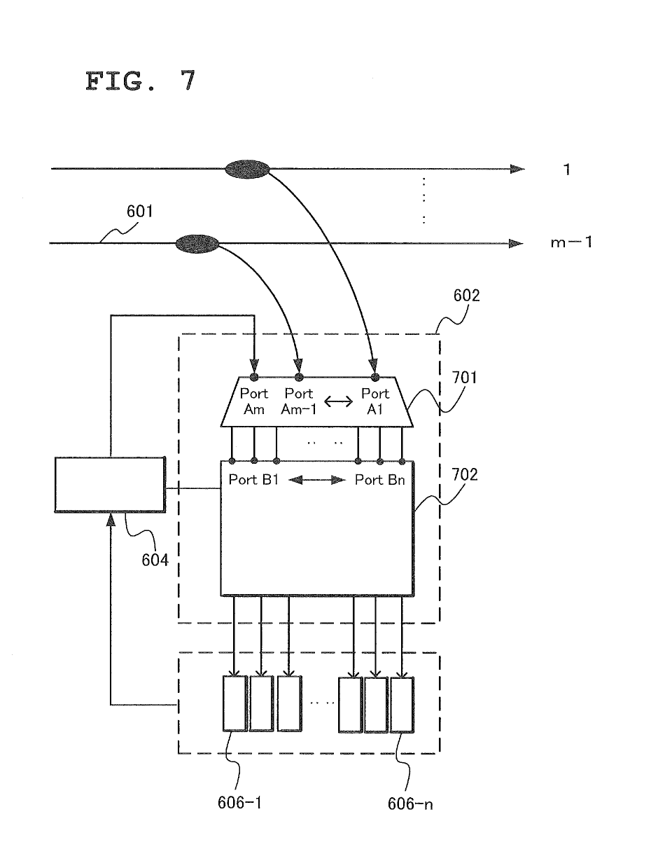

FIG. 7 is a block diagram showing a structure of the wavelength selective switch (WSS) 602 for Drop for the transponder in the optical node according to the second exemplary embodiment of the present invention.

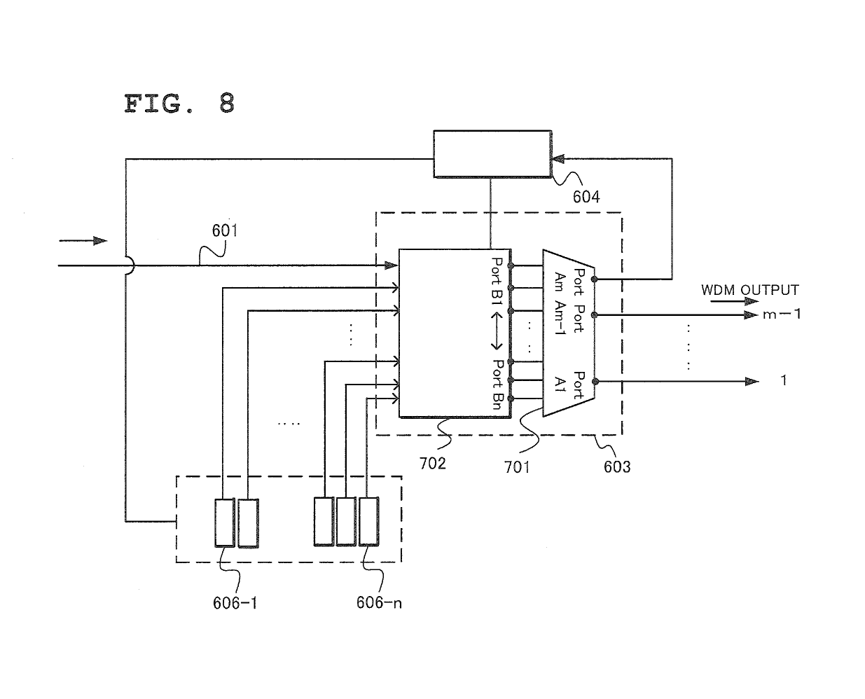

FIG. 8 is a block diagram showing a structure of the wavelength selective switch (WSS) 603 for Add for the transponder in the optical node according to the second exemplary embodiment of the present invention.

Similarly to the first exemplary embodiment, the block diagrams shown in FIG. 6 to FIG. 8 are simplified for explanation's sake, and to the Add/Drop unit between the WDM line 601 and the transponder 606, not only the wavelength selective switches 602 and 603 but also an optical component such as a wavelength tunable filter, an optical amplifier, an isolator or a VOA may be introduced.

Difference of the second exemplary embodiment from the first exemplary embodiment is the number of wavelength selective switches (WSS) 602 for Drop and wavelength selective switches (WSS) 603 for Add with respect to the number of WDM lines 601. The structure of the monitoring system 600 for an optical path and a transponder in an optical node according to the second exemplary embodiment of the present invention is characterized in connecting a plurality of the WDM lines 601 and ports of the AWG 701 in one of the wavelength selective switches 602 and 603 and connecting at least one of the ports of the AWG 701 to a monitor control management unit 604.

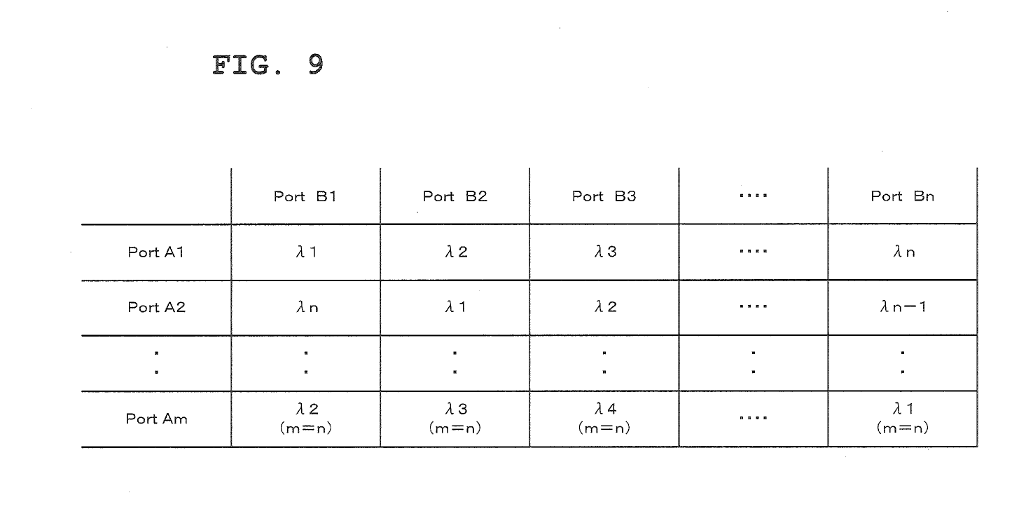

The AWG 701 applied to the second exemplary embodiment is a cyclic-wavelength arrayed-waveguide grating (cyclic-wavelength AWG) in which an output port position cyclically changes depending on an input port position because an input/output wavelength has port dependency. Input/output wavelength table of the cyclic-wavelength AWG 701 is shown in FIG. 9.

Accordingly, in the second exemplary embodiment, a signal from each WDM line 601 is branched by the optical coupler 605 and then connected to a port of the AWG 701 in one wavelength selective switch, and by using cyclic wavelength routing characteristics of the AWG 701, the signal from each WDM line 601 is connected to each transponder 606 by an optical matrix switch 702. Such structure realizes an optical node system which allows an arbitrary transponder to be adapted to each route (WDM line).

With respect to the monitoring system for an optical path and a transponder in an optical node according to the second exemplary embodiment of the present invention, since operation for each of three usages for start-up setting monitoring, failure detection monitoring and active signal monitoring is the same as that of the first exemplary embodiment, no description will be made thereof. When the necessary number of paths or wavelengths is required similarly to the first exemplary embodiment, it is only necessary to upgrade the wavelength selective switch or the transponder which forms the Add/Drop unit provided in the ROADM optical node system with no limitation on the number of paths, the port size of the wavelength selective switch and the number of transponders.

### (Effects of the Second Exemplary Embodiment)

The present exemplary embodiment has an effect, in addition to the effect obtained by the first exemplary embodiment, of realizing an optical node system allowing an arbitrary transponder to be adapted to each path (WDM line).

As described in the foregoing with respect to the preferred embodiments, the monitor system for an optical path and a transponder in an optical node according to the present invention enables monitoring, in an optical path in a node including various components, of an optical path and a transponder in an optical node which allows an accommodated backup/standby transponder or an active transponder to be monitored according to their operation conditions, thereby increasing reliability of a ROADM optical node system.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

An arbitrary combination of the foregoing components and conversion of the expressions of the present invention to/from a method, a device, a system, a recording medium, a computer program and the like are also available as a mode of the present invention.

In addition, the various components of the present invention need not always be independent from each other, and a plurality of components may be formed as one member, or one component may be formed by a plurality of members, or a certain component may be a part of other component, or a part of a certain component and a part of other component may overlap with each other, or the like.

While the method and the computer program of the present invention have a plurality of procedures recited in order, the order of recitation is not a limitation to the order of execution of the plurality of procedures. When executing the method and the computer program of the present invention, therefore, the order of execution of the plurality of procedures can be changed without hindering the contents.

Moreover, execution of the plurality of procedures of the method and the computer program of the present invention are not limitedly executed at timing different from each other. Therefore, during the execution of a certain procedure, other procedure may occur, or a part or all of execution timing of a certain procedure and execution timing of other procedure may overlap with each other, or the like.

Furthermore, a part or all of the above-described exemplary embodiments can be recited as the following claims but are not to be construed limitative.

(Supplementary note 1.) A monitoring system comprising:

a monitor control management unit connected to at least one of ports of wavelength selective switches for monitoring an inspection signal or an operation signal, and

a control unit which controls said wavelength selective switch so as to enable monitoring by said monitor control management unit.

(Supplementary note 2.) The monitoring system according to supplementary note 1, wherein the port of said wavelength selective switch connected to said monitor control management unit is a port of an arrayed-waveguide grating.

(Supplementary note 3.) The monitoring system according to supplementary note 1, wherein said monitor control management unit controls an optical matrix switch of said wavelength selective switch to monitor said inspection signal or said operation signal.

(Supplementary note 4.) The monitoring system according to any one of supplementary note 1 through supplementary note 3, wherein said monitor control management unit comprises a unit which executes feedback control of a transponder based on information obtained by monitoring.

(Supplementary note 5.) The monitoring system according to any one of supplementary note 1 through supplementary note 3, wherein said monitor control management unit is a control management unit including an optical receiver which monitors light, an optical transmitter for checking an optical path and an optical matrix switch controller and capable of seizing a state of an optical signal such as a wavelength, optical power, modulation setting and a polarized wave state.

(Supplementary note 6.) The monitoring system according to any one of supplementary note 1 through supplementary note 3, wherein

said operation signal is an operation signal in operation for start-up setting of a transponder, and

said monitor control management unit monitors the transponder for attaining a constant stable state by start-up operation.

(Supplementary note 7.) The monitoring system according to any one of supplementary note 1 through supplementary note 3, wherein

a target to be monitored by said monitor control management unit is a transponder, and

said monitor control management unit sends a detection signal for failure detection and operates a backup transponder or a standby transponder in response to said inspection signal to monitor reliability of the transponder.

(Supplementary note 8.) The monitoring system according to any one of supplementary note 1 through supplementary note 3, wherein

said operation signal is a signal in operation, and

said monitor control management unit monitors a signal branched by the optical matrix switch to check whether the signal in operation is normal.

(Supplementary note 9.) The monitoring system according to any one of supplementary note 1 through supplementary note 3, wherein at least one of said wavelength selective switches is located in an Add/Drop unit of an optical node of a wavelength division multiplexing transmission system.

(Supplementary note 10.) The monitoring system according to any one of supplementary note 1 through supplementary note 3, wherein said control unit controls the optical matrix switch so as to output a signal from a transponder to a designated arrayed-waveguide grating port.

(Supplementary note 11.) The monitoring system according to any one of supplementary note 1 through supplementary note 3, wherein said control unit controls the optical matrix switch so as to input the inspection signal transmitted from said monitor control management unit to a designated transponder.

(Supplementary note 12.) A monitoring method of a monitoring system having an optical monitoring function comprising the steps of:

monitoring an inspection signal or an operation signal by a monitor control management unit connected to at least one of ports of wavelength selective switches, and

controlling said wavelength selective switch so as to enable monitoring by said monitor control management unit.

(Supplementary note 13.) The monitoring method according to supplementary note 12, wherein the port of said wavelength selective switch connected to said monitor control management unit is a port of an arrayed-waveguide grating.

(Supplementary note 14.) The monitoring method according to supplementary note 12, wherein said monitor control management unit controls an optical matrix switch of said wavelength selective switch to monitor said inspection signal or said operation signal.

(Supplementary note 15.) The monitoring method according to any one of supplementary note 12 through supplementary note 14, wherein said monitor control management unit executes feedback control of a transponder based on information obtained by monitoring.

(Supplementary note 16.) The monitoring method according to any one of supplementary note 12 through supplementary note 14, wherein

said operation signal is an operation signal in operation for start-up setting of a transponder, and

said monitor control management unit monitors the transponder for attaining a constant stable state by start-up operation.

(Supplementary note 17.) The monitoring method according to any one of supplementary note 12 through supplementary note 14, wherein

a target to be monitored by said monitor control management unit is a transponder, and

said monitor control management unit sends a detection signal for failure detection and operates a backup transponder or a standby transponder in response to said inspection signal to monitor reliability of the transponder.

(Supplementary note 18.) The monitoring method according to any one of supplementary note 12 through supplementary note 14, wherein

said operation signal is a signal in operation, and

said monitor control management unit monitors a signal branched by the optical matrix switch to check whether the signal in operation is normal.

(Supplementary note 19.) The monitoring method according to any one of supplementary note 12 through supplementary note 14, wherein at least one of said wavelength selective switches is located in an Add/Drop unit of an optical node of a wavelength division multiplexing transmission system.

(Supplementary note 20.) The monitoring method according to any one of supplementary note 12 through supplementary note 14, wherein said control unit controls the optical matrix switch so as to output a signal from a transponder to a designated arrayed-waveguide grating port.

(Supplementary note 21.) The monitoring method according to any one of supplementary note 12 through supplementary note 14, wherein said control unit controls the optical matrix switch so as to input the inspection signal transmitted from said monitor control management unit to a designated transponder.

(Supplementary note 22.) A monitoring program operable on a computer which realizes a monitoring system having an optical monitoring function, which causes said computer to execute the processing of:

monitoring an inspection signal or an operation signal by a monitor control management unit connected to at least one of ports of wavelength selective switches, and

controlling said wavelength selective switch so as to enable monitoring by said monitor control management unit.

### INDUSTRIAL APPLICABILITY

The monitor system for an optical path and a transponder in an optical node according to the present invention is applicable, for example, to a ROADM optical node system for use in an optical communication system or an optical information processing device.

What is claimed is:

1. A monitoring system comprising:
a monitor control management unit connected to at least one of ports of wavelength selective switches which monitors an inspection signal or an operation signal; and
a control unit which controls said wavelength selective switch so as to enable monitoring by said monitor control management unit.

2. The monitoring system according to claim 1, wherein the port of said wavelength selective switch connected to said monitor control management unit comprises a port of an arrayed-waveguide grating.

3. The monitoring system according to claim 1, wherein said monitor control management unit controls an optical matrix switch of said wavelength selective switch to monitor said inspection signal or said operation signal.

4. The monitoring system according to claim 1, wherein said monitor control management unit comprises a unit which executes feedback control of a transponder based on information obtained by monitoring.

5. The monitoring system according to claim 1, wherein said monitor control management unit comprises a control management unit including an optical receiver which monitors light, an optical transmitter for checking an optical path and an optical matrix switch controller and capable of seizing a state of an optical signal including any of a wavelength, optical power, modulation setting and a polarized wave state.

6. The monitoring system according to claim 1, wherein
said operation signal comprises an operation signal in operation for start-up setting of a transponder, and
said monitor control management unit monitors the transponder for attaining a constant stable state by start-up operation.

7. The monitoring system according to claim 1, wherein
a target to be monitored by said monitor control management unit comprises a transponder, and
said monitor control management unit sends a detection signal for failure detection and operates a backup transponder or a standby transponder in response to said inspection signal to monitor reliability of the transponder.

8. The monitoring system according to claim 1, wherein
said operation signal comprises a signal in operation, and
said monitor control management unit monitors a signal branched by the optical matrix switch to check whether the signal in operation is normal.

9. A monitoring method of a monitoring system having an optical monitoring function comprising:
monitoring an inspection signal or an operation signal by a monitor control management unit connected to at least one of ports of wavelength selective switches; and
controlling said wavelength selective switch so as to enable monitoring by said monitor control management unit.

10. A computer-readable medium storing a monitoring program operable on a computer which realizes a monitoring system having an optical monitoring function, wherein said monitoring program causes said computer to execute the processing of:
monitoring an inspection signal or an operation signal by a monitor control management unit connected to at least one of ports of wavelength selective switches; and
controlling said wavelength selective switch so as to enable monitoring by said monitor control management unit.
